(19) United States
(12) Patent Application Publication
(10) Pub. No.: US 2015/0304187 A1
(43) Pub. Date: Oct. 22, 2015

(54) Bandwidth Management in Local Premise Networks

(71) Applicant: Invent.ly LLC, Woodside, CA (US)

(72) Inventor: Stephen J. Brown, Woodside, CA (US)

(73) Assignee: Invent.ly LLC, Woodside, CA (US)

(21) Appl. No.: 14/288,710

(22) Filed: May 28, 2014

Related U.S. Application Data
(63) Continuation-in-part of application No. 14/255,473, filed on Apr. 17, 2014.

(51) Int. Cl. H04L 12/26; G06F 3/0484; G06F 3/0481; H04L 12/927; H04L 12/911

(52) U.S. Cl. CPC H04L 43/08; H04L 47/801; H04L 47/821; G06F 3/04817; G06F 3/04842

(57) ABSTRACT

A smart premise system has a router having a processor, connection to a data repository, a primary port to Internet connection on a primary path, and wired connection or wireless coupling to individual ones of a plurality of bandwidth-using devices forming a local premise network, bandwidth-using devices sharing bandwidth on the primary port, and software executing on the processor from a non-transitory medium, execution of the software providing a default bandwidth share and a set of rules for registered users and registered devices in the smart premise system, the default share managed by the router according to the default rules for each user of the system using a registered device, and a mechanism for individual users to monitor their own bandwidth share in real time, and to request additional bandwidth from the system.

### CROSS-REFERENCE TO RELATED DOCUMENTS

The instant application is a Continuation-in-Part of pending application Ser. No. 14/255,473 filed Apr. 17, 2014, and claims priority to that application. The priority application is incorporated in its entirety into the instant application at least by reference.

### BACKGROUND OF THE INVENTION

1. Field of the Invention

The present invention is in the field of smart premise technology and pertains particularly to methods and apparatus for managing bandwidth for smart networks and appliances, including managing bandwidth options among multiple bandwidth-consuming appliances or devices within the networks.

2. Discussion of the State of the Art

With the advent of the Internet and of relatively seamless communications capabilities that now exist between sub-networks of the Internet, including communications carrier networks, service providers are marketing smart technologies that bundle different types of digital services that may be delivered through a single premise network router or hub. The fact that a single router or hub may efficiently handle all of the communications and media routing to appropriate end appliances local to the router helps to reduce or otherwise streamline the complexity of many smart premise networks (SPN).

There are, however, drawbacks in bundling services to use one conventional network router for communication. The local premise network becomes vulnerable to bandwidth fluctuation which can result in idling of digital services running alone or in tandem with other services, and also to varying demand for bandwidth among the variety of consumers connected through the router. With these vulnerabilities it has occurred to the inventor that clients using smart technologies, including bundled communications and media services, would benefit if access to bandwidth could be prioritized and managed intelligently.

Therefore, what is clearly needed is a smart premise networking router system that includes functionality to monitor bandwidth availability, to prioritize individual users on the local network, and to throttle bandwidth accordingly at need.

### BRIEF SUMMARY OF THE INVENTION

In one embodiment of the invention a smart premise system is provided, comprising a router having a processor, connection to a data repository, a primary port to Internet connection on a primary path, and wired connection or wireless coupling to individual ones of a plurality of bandwidth-using devices forming a local premise network, bandwidth-using devices sharing bandwidth on the primary port, and software executing on the processor from a non-transitory medium, execution of the software providing a default bandwidth share and a set of rules for registered users and registered devices in the smart premise system, the default share managed by the router according to the default rules for each user of the system using a registered device, and a mechanism for individual users to monitor their own bandwidth share in real time, and to request additional bandwidth from the system.

In one embodiment the software provides a help initiation signal for individual registered devices, the signal, asserted, providing an interactive interface on a display associated with the device. Also in one embodiment the signal is one of a key or key sequence for an input device associated with the registered device, or an icon or other graphic artifact displayed interactively on a display associated with the device. Also in one embodiment the interactive interface provides an input field for a user to enter a password or PIN number identifying the registered user to the system. In one embodiment the interactive interface provides an alphanumeric or a graphical indication of the bandwidth share afforded the user requesting help.

In one embodiment the interactive interface provides an entry mechanism for a user to request a change in bandwidth share. In one embodiment the interactive interface provides an input mechanism for a user to indicate a time period for which an increase in bandwidth is requested. Also in one embodiment, in response to the help initiation signal being asserted, the software provides general suggestions for improvement in bandwidth share. Still in one embodiment the general suggestions include possible movement of a device within the system, switching to an alternative connection to the Internet, or using the device at a different time. And in one embodiment, in response to a user asserting the help initiation signal, the system assigns to the requester a default priority associated with a different user having a higher priority.

In another aspect of the system a method is provided comprising steps (a) executing help software from a non-transitory medium on a processor of a router in a system wherein registered users and registered devices are accorded a default priority for sharing bandwidth through the router, and (b) providing by the software a mechanism for individual users to monitor their own bandwidth share in real time, and to request additional bandwidth from the system.

In one embodiment of the method the software provides a help initiation signal for individual registered devices, the signal, asserted, providing an interactive interface on a display associated with the device. Also in one embodiment the signal is one of a key or key sequence for an input device associated with the registered device, or an icon or other graphic artifact displayed interactively on a display associated with the device. Also in one embodiment the interactive interface provides an input field for a use enter a password or PIN number identifying the registered user to the system. Still in one embodiment the interactive interface provides an alphanumeric or a graphical indication of the bandwidth share afforded the user requesting help.

In one embodiment the interactive interface provides an entry mechanism for a user to request a change in bandwidth share. In one embodiment the interactive interface provides an input mechanism for a user to indicate a time period for which an increase in bandwidth is requested. Still in one embodiment, in response to the help initiation signal being asserted, the software provides general suggestions for improvement in bandwidth share. In one embodiment the general suggestions include possible movement of a device within the system, switching to an alternative connection to the Internet, or using the device at a different time. And in one embodiment, in response to a user asserting the help initiation signal, the system assigns to the requester a default priority associated with a different user having a higher priority.

### BRIEF DESCRIPTION OF THE SEVERAL VIEWS OF THE DRAWINGS

FIG. 1 is an architecture diagram depicting arrangement of elements in one embodiment of the invention.

FIG. 2 is a block diagram depicting detail of elements in a router in one embodiment of the invention.

FIG. 3 is a block diagram depicting multiple connected bandwidth consumers to a smart router.

FIG. 4 is a diagram of a matrix in determining priority levels for users and devices in an embodiment of the invention.

FIG. 5 is a flow diagram depicting a process in one embodiment of the invention.

FIG. 6 is a diagram depicting a smart-premise layout in an embodiment of the invention.

FIG. 7 is a diagram illustrating operation of software in a help system in an embodiment of the invention.

FIG. 8 is a flow diagram illustrating adjustment of bandwidth allocation for members of a smart premise network in one embodiment of the invention.

### DETAILED DESCRIPTION OF THE INVENTION

In various embodiments described in enabling detail herein, the inventor provides a unique system for managing bandwidth for multiple bandwidth-sharing appliances connected to a smart network in a home or business (premises). The present invention is described using the following examples, which may describe more than one relevant embodiment falling within the scope of the invention.

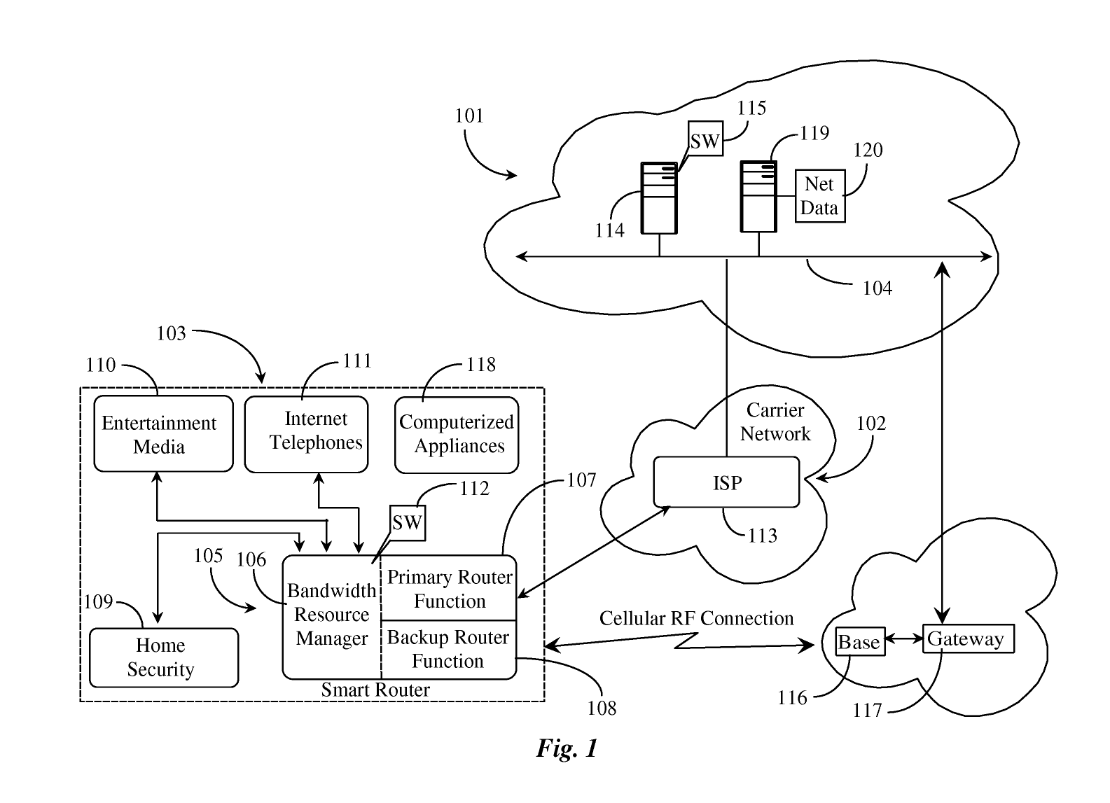

FIG. 1 is an architecture diagram depicting arrangement of elements in one embodiment of the invention. The system as shown includes elements in the Internet network. The Internet network 101 is further characterized by a network backbone 104 that represents all of the equipment, lines and access points that make up the Internet as a whole including any connected sub-networks. Therefore there are no geographic limitations to the practice of the invention. Internet 104 may be a corporate WAN or a combination of wide area networks without departing from the spirit and scope of the invention. The inventor illustrates the Internet as a preferred network because of wide public accessibility characteristics.

The unique system comprises a Smart Router 105 having a Bandwidth Resource Manager 106, a primary router function 107 and a backup router function 108. Among the different sorts of Internet access known, the primary router function will be in typical cases either Digital Subscriber Line (DSL) through a telephone carrier, a cable modem, or some sort of optical network connection to the Internet. Other forms, which may be more expensive and may provide less bandwidth, or both, will be used for backup in case of loss of, or severe restriction of the primary router path.

In FIG. 1 a carrier network 102 having an Internet Service Provider (ISP) 113 is shown to illustrate the primary router function. In this example a cellular path is illustrated as the backup path, connecting to a base station 116 by RADIO FREQUENCY (RF), thence through a gateway 117 to the Internet. The backup might in some instances also be a satellite service.

It should be noted that the provision of a primary and a backup path for access to the Internet is not a limitation in all embodiments of the present invention. In some cases there may be only one path, and that may be a relatively low bandwidth path, but this does not preclude bandwidth monitoring and management for individual ones of access points in a local network.

The terminology “smart-home” as is often used with smart networks at local residences should not be taken to limit the invention to residences, and premise is used in this specification as a more general term to indicate that the systems and functions described in various embodiments may service homes, businesses, and networks in other organizations without departing from the spirit and scope of the present invention.

Smart router 105 is illustrated in this example as providing access to the Internet for a Smart Premise Network 103, which includes Internet telephone service 111 at various points in network 103, entertainment and media systems 110 that may include such as television, gaming systems, and the like, home security apparatus 109, and various and sundry computers, such as laptops, iPads, and other computerized appliances.

In this environment router function 107 handles all data traffic between bandwidth-using elements of local network 103 and resources in the Internet. It is self-evident that gathering all of the appliance and systems on a single network that communicates through a single router minimizes expense and complexity of managing the local network. However, it is also true that the one router and network provider creates an increased vulnerability for all of the networked appliances and systems to network bandwidth availability issues that might arise. It is also true, that in the estimation of an owner or manager of network 103, not all of the bandwidth-using elements in network 103 are equally deserving of maximum bandwidth, should bandwidth become scarce. In a situation where the supply is copious, and the demand of network 103 is far less than the supply, all elements in 103 may be afforded unfettered access. If, however, demand should increase beyond supply, then a means of prioritizing and managing bandwidth among competing interests is highly desirable.

Returning to FIG. 1, a server 114 is provided in one embodiment in the Internet network. Server 114 includes a processor, at least one data repository, and software (SW) 115 executing from a non-transitory medium on the processor, the SW comprising all instructions required to function as a Web server. In one embodiment, a Web site is provided by SW 115 to owners or managers of smart premise networks so that they may register for bandwidth optimization notifications. Server 114 may be hosted by the provider of network services and the smart router. In one embodiment SPN's may be managed remotely through SW 115.

Server 114 has access on the Internet, and by executing SW 115 to a server 119 that in one embodiment monitors Internet connection patterns and fluctuations, and information from various bandwidth providers, such as telephone interchanges and cable providers. Such information may be recorded and processed to determine predictive patterns for bandwidth availability by geographic region, and may be used by server 114 to provide updates to registered smart premise networks as to expected variations in bandwidth availability in the particular regions where the smart premise networks may operate. Such warnings may be used by bandwidth resource manager 106 in some circumstances to aid in bandwidth allocation within smart premise 103, or to cause a switch to a backup router path, for example.

There are many known causes for bandwidth fluctuation for a smart premise network. Consider in the case that the primary router function 107 is a DSL or a cable connection, there may be several users in one neighborhood all sharing a connection of a single maximum bandwidth. If one user A has a requirement for a certain total bandwidth, and is accessing this service at 3:00 AM, that user may have no problem. But at another time two neighbors may be watching movies, and the bandwidth available to user A will be curtailed. Other causes may be problems in telephone lines over which a DSL connection may be carried. Temperature fluctuations in equipment may cause fluctuations in bandwidth capability. There are many different conditions which may affect available bandwidth for one smart premise network.

To provide for management of bandwidth within smart premise network 103, smart router 105 includes bandwidth resource manager 106. Bandwidth resource manager 106 may share a CPU, which may be a microprocessor, and operational memory (not illustrated here) with router functions 107 and 108. Bandwidth resource manager 106 executes coded instructions (SW 112) from a non-transitory medium.

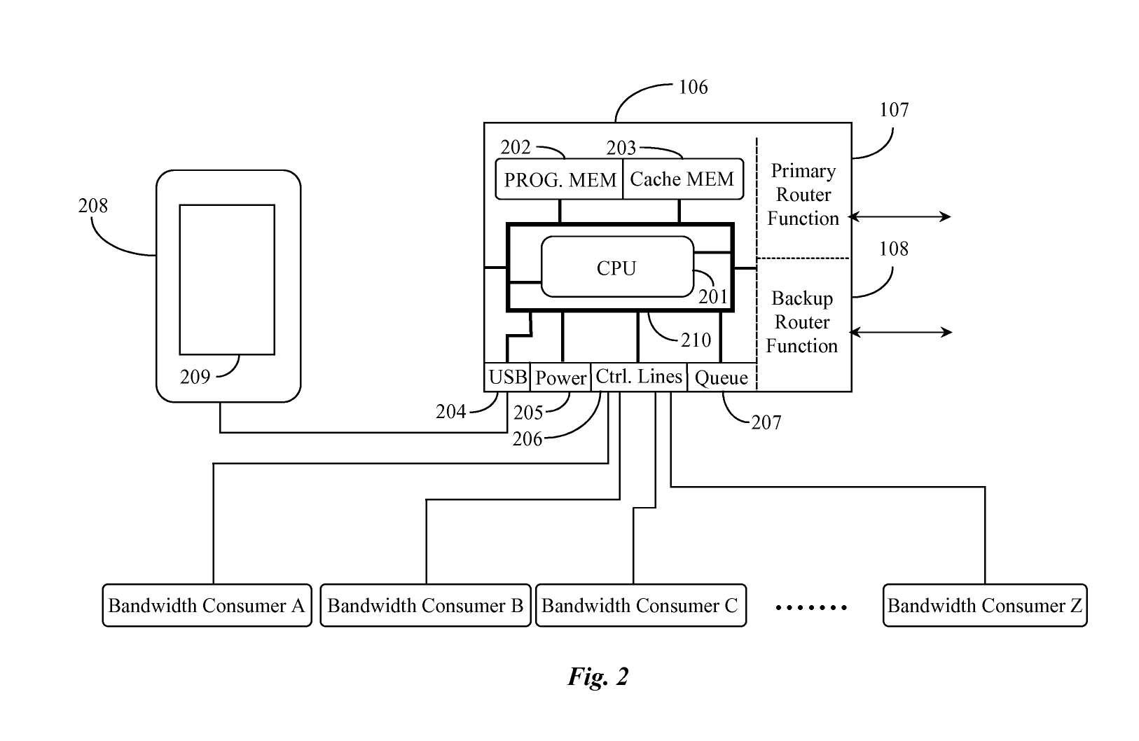

FIG. 2 is a block diagram depicting a smart premise network with a router having bandwidth resource manager components depicted in more detail in one embodiment of the invention. Bandwidth resource manager 106 includes a central processing unit CPU 201, which may in some embodiments be a microprocessor. Processor 201 communicates with other components through a BUS structure 210 illustrated logically herein and for discussion purposes.

Microprocessor 201 has access to a programmable (PROG) memory (MEM) 202. MEM 202 contains all of the coded instruction (SW 112) required to provide bandwidth management and ordered prioritization relative to bandwidth consumers A-Z that may be active in a smart premise network such as network 103 of FIG. 2. MEM 202 may include a non-volatile memory such as a flash memory or a read-only memory (ROM) including variations thereof. MEM 202 may also include a volatile memory portion such as a random access memory (RAM) or any variation thereof.

In a local premise network, some of bandwidth consumers A-Z may be smart devices having an IP address and capable of wireless (or wired) network connection, and for these consumers bandwidth management may be done wirelessly from smart router 105 sending data and commands. For consumers that do not communicate wirelessly, control lines 206 may be provided to control bandwidth settings associated with those consumers. In one embodiment, bandwidth settings connected to the device modem may be manipulated by SW 112 over a control line or via wireless communication to lower the maximum amount of bandwidth the device receives.

Control lines 206 may also be leveraged to control the on/off state of that consumer's network router connection and therefore, access to remote communication on the Internet or on a broader connected network. In one embodiment access to the router channel for a particular bandwidth consumer is performed on the smart router in both wired and wireless embodiments.

Processor 201 has access to a cache memory (MEM) 203. MEM 203 contains temporary data including activity logs, communication logs, temporary settings, etc. Cache MEM 203 may be a high speed RAM or other MEM type suitable for high speed caching and access to cached data. Bandwidth resource manager 106 includes a power interface 205 in this example. An internal battery may be used in the event of loss of another power source. In one embodiment bandwidth resource manager 106 includes a switch circuitry that automatically switches to internal battery power if no other power source is available due to a power outage.

In one embodiment switch circuitry (not illustrated) is provided to enable processor 201 to switch over from one source of power to another based on notification of one or more conditions. It is important to note herein that processor 201 may affect switch over from one power source to another based on an actual event that occurs without warning such as unpredictable loss of a source of power currently being drawn by way of act of nature or other accident. In this embodiment processor 201 may also switch over from one power source to another based on receipt of a notification containing information that causes prioritization of power source selection. In case of an actual loss of power event that occurs without prediction, the switchover is hard-wired and occurs by default.

In one embodiment smart router 105 may include a universal serial bus (USB) port 204. USB port 204 may be used to communicate via USB cable to a peripheral computing appliance 208 such as a tablet device with a display 209 and input capability (touch screen). In one embodiment USB port 204 is a wireless USB port or another type of port supporting another type of wireless communications technology such as Bluetooth, infrared, radio frequency (RF), etc.

In one embodiment a premise network owner or service technician may connect appliance 208 to smart router 105 via USB port 204 to provide new component prioritization instruction, modify existing priority instruction, or to troubleshoot the system. Processor 201 may recognize appliance 208 when plugged into port 204 and powered on, and may serve an electronic user interface (UI) stored in PROG MEM 202 for use in interaction with the manageable parts of the system. In another embodiment, a user interface for configuring bandwidth resource manager 106 may be accessible remotely through router function 107 by navigating on the network using a browser interface to the IP address of Router 105.

Smart router 105 includes a queue 207 in one embodiment for queuing messages including control messages from smart premise network administrators, and alerts or notifications from a central server analogous to 116 of FIG. 1. Queue 207 may be shared by bandwidth resource manager 106 and router functions 107 and 108. There may also be separate dedicated queues for each component (router function and bandwidth resource manager). Queue 207 may be a first-in-first-out (FIFO) queue or a prioritized queue wherein certain alerts or notifications take priority over other routine messages. Such alerts or notifications may be those that inform bandwidth resource manager 106 of a predicted bandwidth availability issue. Bandwidth alert or notifications may include parameters about the predicted event. The alert or notification may include an event title or an event category such as “bandwidth availability alert”. The alert or notification may include the exact nature of the alert. For example, intermittent bandwidth outages predicted for today between 12:00 PM and 5:00 PM. The alert or notification may include a time window or a time to live (TTL) for the alert to be in effect.

Alerts or notifications may be flagged in queue 207 according to one or more levels of priority. An alert table or scheme may be provided that may trigger one or more preset bandwidth management states to be initiated by bandwidth resource manager 106. That is to say that the nature of an alert or notification may cause microprocessor 301 of bandwidth resource manager 106 to initiate a preset bandwidth management state according to priority settings previously input into the bandwidth resource manager by an administrator of the smart premise network.

As an example, assume that bandwidth consumer A is a media entertainment system and service such as an online interactive gaming system, and that bandwidth consumer B is an office network connecting an office worker to the Internet. If an alert is received at 9:00 AM warning of a bandwidth scarcity with possible interruptions between 12:00 PM and 5:00 PM on the same date, bandwidth resource manager 106 may equate the alert to a preset bandwidth management alert level that has been associated or linked to a preset bandwidth management configuration. Bandwidth resource manager 106 may initiate a bandwidth shutdown for Internet gaming system A to begin at 12:00 PM to remain in effect until 5:00 PM, leaving available bandwidth to consumer B. The bandwidth shutdown may be accomplished via disconnecting the system from the router channel. Other alternatives may include switching the bandwidth settings on the system to lower bandwidth operation or actually shutting the system down for the alert TTL.

In one embodiment, bandwidth alerts come into bandwidth resource manager 106 via the router function 107 and connection to the Internet network illustrated herein by a double arrow emanating from router function 107. Such alerts have been generated on a central server like server 116 of FIG. 1 from intelligence from various sources described further above with respect to FIG. 1. Alerts having a same geo-tag indicative of the geographic area covered in an alert are sent to smart premise networks located in those geographic areas. In one embodiment, after the time window associated with an alert has passed, bandwidth resource manager (BRM) 106 may reset bandwidth consumers A-Z back to their pre-alert priority states.

In this example bandwidth resource manager 106 is hosted on smart router 105 along with routing components 107 and 108. However, in an alternative embodiment the functionality of bandwidth resource manager 106 may be implemented on a completely separate hardware such as a dedicated smart premise network processor with a router connection without departing from the spirit and scope of the present invention. In one embodiment a smart premise network may receive one or more alerts and may initiate a bandwidth management priority state affecting one or more bandwidth consumers A-Z when no administrator is available or at the location of the network. In such instances bandwidth resource manager 106 may be capable of generating short messages to inform a remote administrator of the activity through the onboard routing function. The administrator may receive such activity notifications in email, on social media pages, on a mobile device, or by automated phone call. In one embodiment, an administrator may intervene and override alert-triggered bandwidth priority settings on site or from a remote location using a Web-connected communication appliance having a browser, a display and a means of data input.

In one embodiment the schedule of the smart premise network administrator is taken into account when creating priority settings for the bandwidth consuming appliances and systems. For example, when there will be no one on site, BRM 106 may maintain a lower bandwidth management profile for one or more bandwidth consumers.

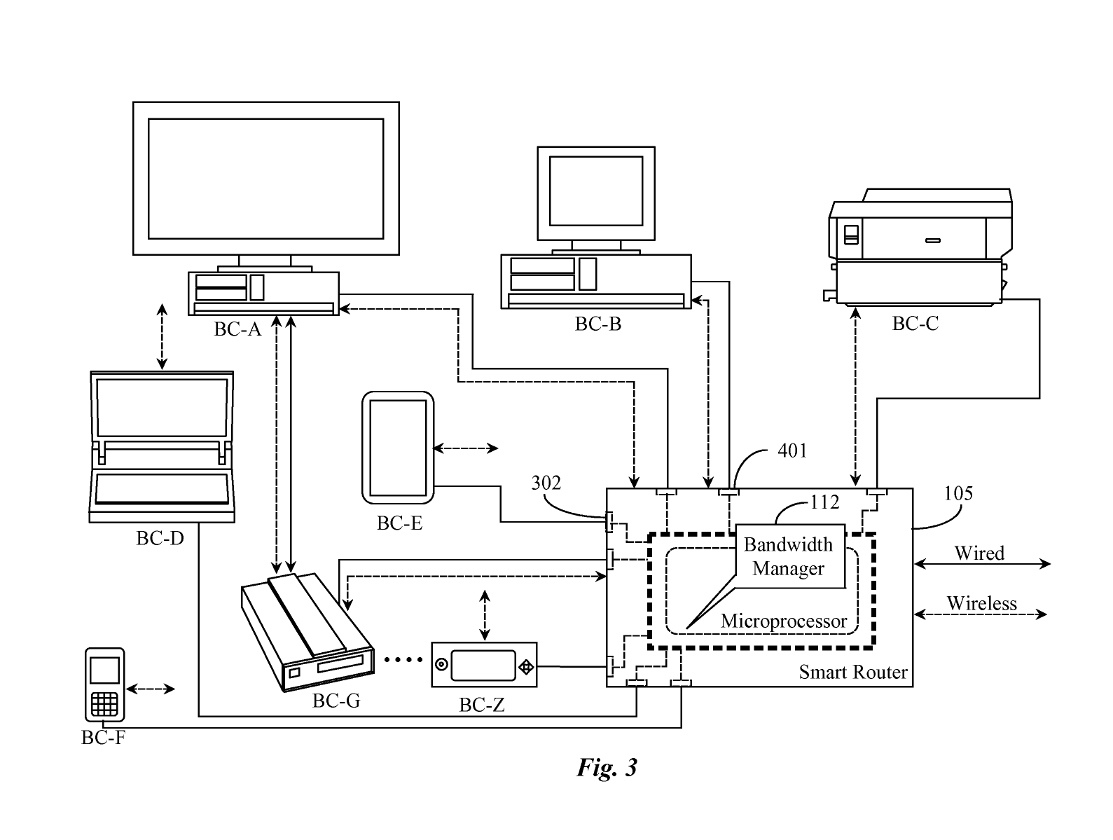

FIG. 3 is a block diagram depicting multiple bandwidth consumers connected to a smart router 105. The diagram represents a smart premise network analogous to network 103 of FIG. 1. Smart router 105 may have wired access and wireless access to the external network such as the Internet network. In this example several bandwidth consumers (BC) are depicted connected to smart router 105 for reference. BC-A is an entertainment media system. BC-A has connection to smart router 105 via one of several connection ports 301. BC-A may also communicate wirelessly through smart router 105 as indicated herein by a broken double arrow adjacent to the wire line. BC-B is a desktop work computer station. BC-B has a wired connection to a port 301 on smart router 105 and an alternative wireless connection through router 105. BC-C is a network printer. BC-C has a wired connection to smart router 105 and a wireless connection to the router.

Some networked devices may have wireless connection for communication and Internet access through a G(x) carrier network and may, in some cases, be able to access the Internet and reserve sufficient shared bandwidth at a time when smart router 105 is not able to reserve sufficient bandwidth for operation. BC-D is a laptop computer that may connect by wire to router 105 or wirelessly to the external Internet without requiring connection to router 105. Likewise, BC-E is a notepad touch screen device. BC-E may also be connected by wire to router 105 and may also have network capability independent of router 105.

BC-F represents a cell phone with wireless network capability independent of router 105. BC-F may connect to outer 104 by wire to one of ports 301 as previously described. Other devices include BC-G, which is a gaming box in this example. BC-G may connect to router 105 by wire or wireless connection. BC-G may also communicate with BC-A for visual display and sound system for playing Internet-based Games. BC-Z represents a hand-held mobile gaming device. BC-Z has wireless access through a private carrier to the Internet independent of router 105. BC-Z may connect to router 105 and access the network through the router.

The bandwidth manager through execution of SW 112 may monitor and manage or regulate how bandwidth is reserved by clients of the router. In one example, BC-G is reserved bandwidth of sufficient speed and quality for gaming interaction. In a same time frame as Internet gaming activity involving BC-G and BC-A, BC-B and BC-C may be connected to router 105 and reserving sufficient bandwidth for networking and transacting with other remote office nodes on other network segments. The minimum bandwidth requirements must be exceeded in order to enable simultaneous operation of all of the activities involving various competing BCs.

Smart router 105 may receive a message from a central server analogous to server 116 of FIG. 1 hosting SW 117, the SW executable from a non-transitory medium on the processor of the server. The message may be an alert notification predicting a bandwidth scarcity event that is geographically directed and predicted for a specific period of time. The time period may be characterized as having a start time and an end time characterizing the scarcity event. Such an event may take the form of one of more than one alert severity levels that instruct or otherwise trigger a decision on smart router 105 relative to bandwidth management options available to the router.

Bandwidth management options may include, but are not limited, by denying access to bandwidth to selected devices currently reserving bandwidth for communication. An alert notification having an alert level 2 of 3 levels, for example, may trigger some bandwidth management action on the router. In this case router 105 with the aid of SW 112 may, after processing the alert data, execute logic to deny access to (switch off) bandwidth to BC-G and BC-A, thus reserving the available bandwidth for BC-B and BC-C. Such prioritization may be a product of administrative input by an authorized SPN administrator.

In one embodiment of the invention, router 105 may reset a peripheral device's modem settings in order to down regulate the amount of bandwidth the device might use while connected and consuming bandwidth through the router. In one example, BC-C may receive and send data over the network relative to scanned digital documents and high resolution images, communication facsimiles, etc. Router 105 might, after processing an alert, reduce the amount of bandwidth the printer may access, leaving some activities operational but not others. This may be accomplished over a wired connection between the printer and the router.

Logic on the router (SW 112), and perhaps a thin SW client executable from a non-transitory medium on the processor of the printer, may result in a reconfiguring operation on the modem installed on the printer. Although the connection supports the maximum bandwidth speed, the channel may be narrowed to only enable the device to process under a smaller range of bandwidth. The printer then may be reconfigured on the fly to only accept a smaller amount of bandwidth sufficient for fax communication but not for high resolution image transfer and print jobs, for example.

In one embodiment certain mobile devices may be executing home health monitoring applications or security applications. In a severe bandwidth shortage affecting wireless access through a G(x) network, such devices normally depending on those networks for application communications would reserve any available bandwidth from the router according to priority settings.

A critical parameter in embodiments of this invention is bandwidth available on the primary path to the premise as a whole, and this parameter may be measured on a periodic basis by the router executing SW 112, or continuously. Bandwidth variation and outages may be recorded by date and time, and patterns may be determined to be saved and used in management protocol.

In one embodiment bandwidth fluctuation data recorded by bandwidth resource manager (BRM) 106 may be managed for each bandwidth consumer on the network according to priority settings enacted in part through administrative preferences and according to bandwidth cost modeling for each bandwidth consumer. In another variation of this aspect, the client owner of the premises (business or home) may authorize third-party access to bandwidth usage data records maintained for that SPN at a server on the Internet or in a database maintained by smart router 105.

Bandwidth resource manager 106 comprises I/O capability for a network manager or administrator, which may be a homeowner in some embodiments, to set priorities for bandwidth for individual ones of bandwidth-consuming devices in the local network. This capability may be, in one embodiment, connection to an appliance with general-purpose computer capability, enabled to provide a manager with an interactive interface. In one embodiment, remote access to bandwidth resource manager 106 is provided through a Web page hosted by the smart router, as the router is accessible by an IP Address.

It is to be understood that priority is not necessarily strictly associated with a device. Priority may also be associated with use. For example, a device that may be used to make a telephone call may have a certain priority as a device, set by a manager with access to the priority record, but priority, and therefore bandwidth, may be raised according to a telephone number that is asserted. A device with one priority, used to call 911, may be automatically bumped to higher priority and extra bandwidth made available (possibly at the expense of some other use in the premise) if need be for the call to be placed.

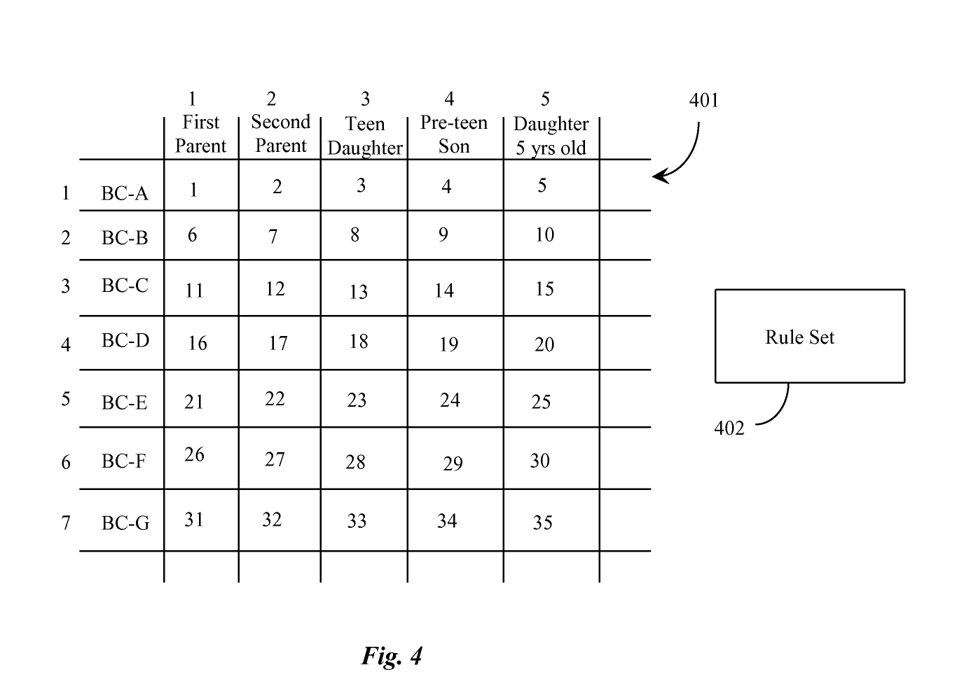

FIG. 4 is an exemplary diagram 401 of a priority matrix wherein devices BC-A through BC-Z are arranged on a vertical axis, and users of these devices are arranged on a horizontal axis. In this example the network is a home network, and the family members are Father, Mother, teenage daughter, pre-teen son and five year old daughter. If the devices BC-A through BC-G on the network are listed as device priority 1 through 7, and the family members are listed left to right as personal priority 1 through 5, then the priority at each intersection for a person using a device is the product of the two priorities. Shirley, using device BC-D then has a priority rank 18 of 35.

It is not necessary in the prioritization for the manager to draw the matrix, but simply to order the priority of the devices and users. The software can do the rest. And in addition to the granular priority that may be accomplished this way, there may also be rules in various embodiments to provide exceptions and to provide for any special conditions. For example, as mentioned above, if the Mother is using device BC-F, which is a cellular telephone, the default priority is 27th. But if Mother is calling Father, a rule may be imposed to bump that priority to 7. If the Mother is using BC-F to call 911, priority may be bumped to 1, so the call cannot fail for lack of bandwidth. A set of rules 402 is indicated in FIG. 4. In configuration process there may be standard rules which may be selected and applied in the rule set, and a facility may be provided to create new rules.

In another example the bandwidth resource manager may simply regulate which bandwidth consumers on the network may have permission to access bandwidth from the router connection. That is to say that a bandwidth consumer competing on the network for outside communications may be suspended from its router access but not specifically shut down relative to its power source. For example, a child's laptop that is wirelessly connected and running on internal battery power may be suspended from communicating with the router when the priority status indicates low priority for the bandwidth consumer (laptop) and operator (child). The activity of gaming might also be a low priority in a power uncertainty state. Such a suspension may last until conditions change sufficiently to warrant reconnection of the appliance to the bandwidth channel.

Other considerations may be observed and applied relative to bandwidth management in a smart premise network without departing from the spirit and scope of the present invention, such as considering distance of connected appliances and systems from the router in a wireless embodiment. In one embodiment the router may operate with divided frequencies. The router may also include a combination of wired connections, optical connections, and wireless connections. In some cases lower-priority appliances or systems are automatically shut down, limited in their capacity to access services (router connection), or switched to operate on a narrower bandwidth capacity while active on the network.

In one embodiment an owner or manager might set priorities for different bandwidth-consuming devices and uses in the premise network as follows, in top-down order of priority:

1. Security communications

Devices and uses that may be included as highest priority in this category are emergency communications, like 911 calls or a pre-defined call list, security monitoring systems like ADT™, smoke alarms like Nest™, and various health-monitoring devices. Priority may be set separately and hierarchically within this or another category as well.

### 2. Basic Communication

This applies to telephones, emails, texting, and other generally low-bandwidth uses.

### 3. High Bandwidth Communications

These may be video conferencing or large email attachments.

### 4. Work/School

Generally applications and file transfers, but may include watching videos.

### 5. Entertainment

Gaming, watching TV, watching cats in YouTube™, etc.

Once configuration is accomplished for a smart premise network in an embodiment of the invention, the bandwidth resource manager monitors available bandwidth, tracks uses on the network, and applies the priorities set and the rules established to allocate and throttle bandwidth for different devices and users.

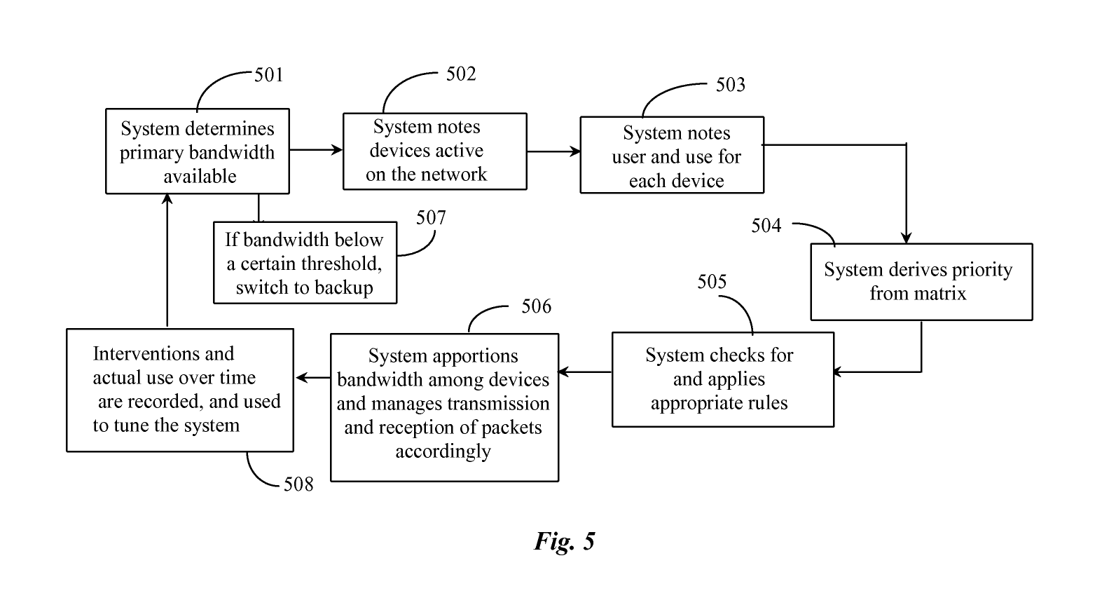

FIG. 5 is a flow diagram illustrating operation of bandwidth resource manager 106 in an embodiment of the invention. Periodically the system determines the real bandwidth available on the primary path 107 at step 501. If that bandwidth is zero or below a pre-set threshold, the system switches at step 507 to backup path 108, and continues to check the bandwidth available on the primary path. If the bandwidth on the primary path then reaches a preset threshold, the system may resort again to the primary path. The thresholds to switch in either direction are not necessarily the same.

At step 502 the system noted the devices active on the network. A device that is not powered on and capable of communicating is not included in determinations. At step 503 the system notes the user and the use for each device active. At step 504 the system derives priority from matrix 401 and modifies that priority according to use. At step 505 the system checks for and applies appropriate rules. At step 506 the system apportions bandwidth among the active devices. Then the system returns to step 501 and again determines bandwidth in the primary path, which may not have changed. The loop continues, keeping bandwidth allocation properly apportioned.

There are a number of different methods that might be used to throttle bandwidth for devices on the network. Most rely on checking packet headers, which will indicate the originating devices on the network and destinations for packets. Cache memory may be used to store packets and order packets for transmission. In a rough example, there may be two devices seeking bandwidth with one having priority over the other. The system may send, for example, two packets for one device, then one packet for the other. This may be extrapolated for a number of devices and uses to intermingle packet transmission in a manner that accomplishes the purpose.

It should be noted that bandwidth management in embodiments of the invention is not a one-way street. However, packet transmission and reception may both be throttled and controlled in embodiments of the invention. Packets arriving at smart router 105 may be managed by bandwidth manager 103 to be delivered to different devices on the network, similarly to the way packet routing may be interleaved in outbound transmission.

In embodiments of the invention default priority may be set for devices and users, and determined for users of devices as described above, and rules may be set and applied. Still, one or more authorized users may command certain changes in the operation. The Father may, for example, have a very large email attachment to send, and he may intervene in the system to command higher than configured priority for a certain period if he, in fact, has the authority in the system to do so. But even though one or more users may have administrative authority in the smart premise system to arbitrarily change rules, priorities, and other artifacts of configuration, not all users will have such access and authority. Still, users who do not have administrative authority may often have reason to desire some change, even temporarily, to access a greater share of available bandwidth than may be afforded by present circumstances, including the rules and priorities in place at a particular point in time.

In one embodiment of the invention provision is made to help each user maximize his or her experience in the smart premise, and to attain the best share of bandwidth that may be possible for that user in that circumstance, and at that point in time.

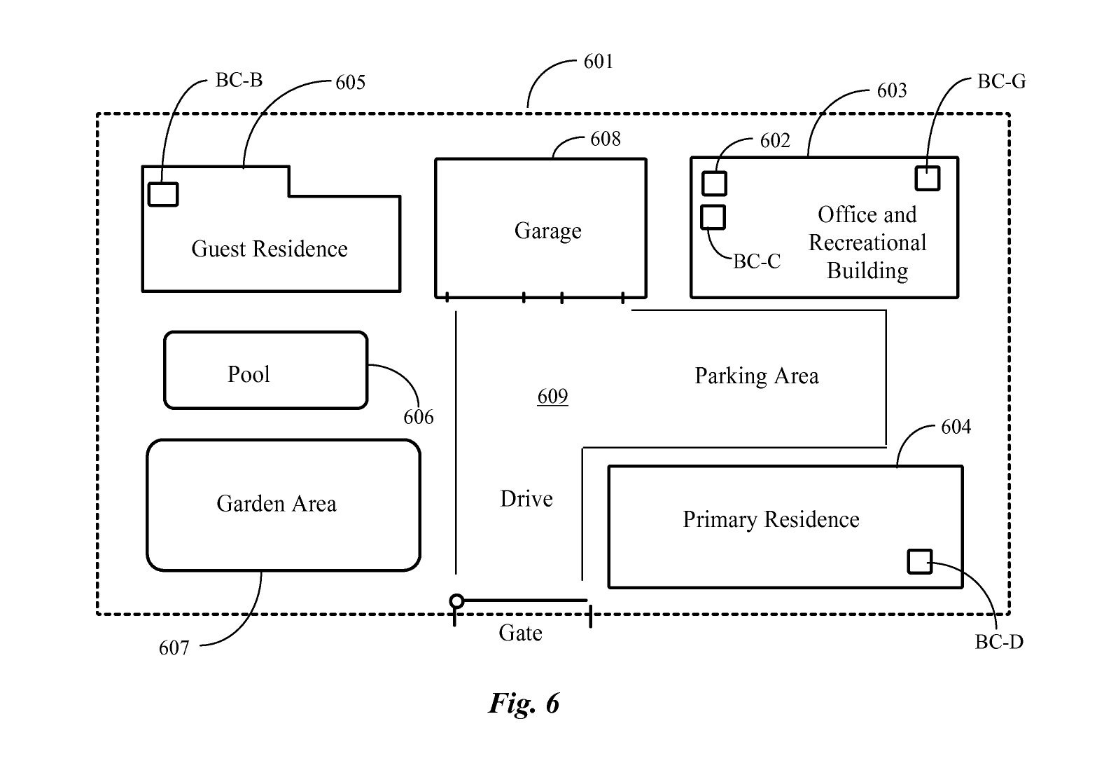

FIG. 6 is a diagram depicting a smart-premise layout 601 in an embodiment of the invention, among a great variety of possible layouts for a smart premise network. In premise 601 there are several separate buildings divided by gardens and courtyards. The smart router 602 for the premise is located in one place, in this case in a stand-alone office and recreational building 603 used primarily by the head of the family, who, in this example, i8s the Father in the family, and a very serious businessman with several projects in different stages of development at any one time. The Father is also the one person associated with this smart-premise network, in this example, who has administrative authority to set and edit priorities and rules for users in the premise and bandwidth-sharing appliances used in the premise.

There are in this layout, in addition to the Office building 603, a primary residence building 604, a guest residence building 605, a pool 606, a garden area 607, a garage 608, and a drive and parking area 609. Referring now to FIG. 3, showing a variety of devices that may be used in premise 604, and which may be connected in some circumstances hard-wired, and in other circumstances wirelessly, to smart router 602 in Office building 603, and may be used by individual ones of users in the premise (refer to FIG. 4) who may each have a set priority, and to each of which certain rules may apply, an exemplary location in smart-premise of some of the devices depicted in FIG. 3 is shown in FIG. 6. For example, a desktop computer BC-B of FIG. 3 is located in guest residence 605 for convenience of any visiting guest. Printer BC-C is located semi-permanently in office building 603 near router 602. Laptop BC-D associated with the teen son (see FIG. 4) is usually in this son's bedroom in primary residence 604. Pad devices BC-E, telephones BC-F and portable gaming device BC-Z are not shown as they may be used anywhere in the premise. It should be noted as well that all of the devices are movable, and may vary in location over time as well.

It is to be noted that the priorities and rules once configured are not the only circumstances affecting bandwidth for users of devices in the smart premise network. For example, a wirelessly-connected device operated by a user in the guest house will, barring other restrictions, have a lesser bandwidth than a similar device operated in the office area near the smart router. This is simply because signal strength drops off as the square of the distance to the wireless router. Furthermore, more power is required as a result of further distance in transmission as well.

Another circumstance that must be considered in the case of a user of the smart premise system seeking additional bandwidth beyond that bandwidth the system will allow based on managed priorities and rules, is that an appliance that a user operates to communicate through the smart router may be, perhaps in the background, performing one or more tasks that are commanding bandwidth for that user. For example, the user's appliance may in the background be automatically seeking updates for one or more applications that may be enabled on that appliance, and finding one or more updates may be commanding considerable bandwidth in downloading such updates.

The facts and circumstances described just above lead to example situations that illustrate further functionality in an embodiment of the invention. Referring to FIG. 4 again, it was described above that the priority matrix provides a combined priority for a registered user using a particular registered device in the smart premise. Each registered device has a default priority, and each registered user has a default priority once configuration has been accomplished, so the Mother has a priority of 27 if using telephone device BC-F to share bandwidth through smart router 602.

It will be apparent to the skilled person that telephone device BC-F used by the Mother in this example, may well have multiple connection paths. If BC-F is an iPhone it may connect through AT&T cellular network, and it may also connect wirelessly to smart router 602, and may have limited or unlimited data allowance in the cell network. Further smart router 602 may have alternative paths to the Internet, such as by DSL through PSTN or by cable. In most cases connections will not be dual, as connection will by configuration or some other mechanism be by one of the alternative possible paths. For example, rules may apply in the smart premise according to bandwidth cost under certain circumstances.

Let us assume that in one example the Mother may be using an iPhone BC-F connected wirelessly to smart router 602, and operating through the router as VoIP. According to configuration, referring to FIG. 4, The Mother has a priority of 27 in this circumstance. If she is calling the Father, a rule may be imposed to bump that priority to 7. If the Mother is using BC-F to call 911, priority may be bumped to 1 by rule, so the call cannot fail for lack of bandwidth. But the inventor knows that rules are not infallible, and circumstances extant when the rules are first made may change subtly or drastically. So the Mother, for example, using device BC-F, may have a situation that isn't covered by rule, and may need significantly additional bandwidth on occasion than her pre-programmed combined priority may allow. The same may almost certainly be true for other registered users, but the Mother is used here as an example, which may be extrapolated to other users.

Assume for example to illustrate features of the present invention, that the Mother is using smart telephone BC-F, the telephone is connected to smart router 602 wirelessly, the telephone executes Skype, and the Mother has planned and organized (through email, perhaps) a conference with three business partners, to discuss business strategy in a new business she is initiating.

The Mother, perhaps, has had some experience with the configured system thus far, and is well aware that she has little difficulty in web browsing through smart router 602 using her iPhone. But she may also have had experience with conference calls in which connectivity and clarity is compromised.

In various embodiments of the invention, as described above, software 112 executes on the smart router and may afford a partial solution to the varying needs of registered users like the Mother. SW 112 is described above as managing bandwidth for users of devices in the smart network, based on configured priorities combined for devices and users, also affected by rule set 402, which may account for particular changes in circumstance.

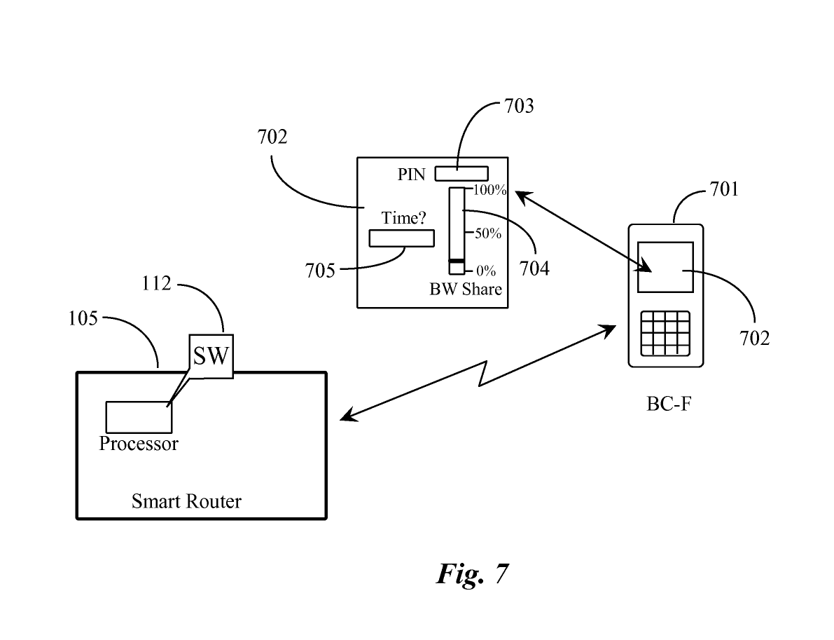

In one embodiment SW 112 further comprises coded intelligence to interface with users in situations where a user has an unusual circumstance or special needs, and the user needs, usually right away, an increase in prioritized bandwidth share. FIG. 7 illustrates the circumstance described above wherein the Mother, operating device BC-F, having a combined priority of 27 on a scale of 35, and trying to initiate and conduct a Skype conference with business associates, may need, at least temporarily, a significantly better bandwidth share.

In embodiments of the invention, as indicated above, both devices and users are registered in the system. The smart router knows each registered device, and when each registered device is active in the system, and whether or not the device is consuming bandwidth. When a smart premise system is configured, the configuring administrator (Mr. Busyman in this example) associates each user with a PIN number, or some other form of a password which a user may enter under certain circumstances to identify the user to the system. Further, when a user has a desire to interact with the machine intelligence of the system, that user will know to enter a signal. The signal may be a key sequence on a computerized device, for example. This is to the smart premise system a HELP signal. There are many ways the HELP signal may be implemented. In some instances every computerized device in the system, if the device has a display, may have an instance of SW 112 executing in background, and there may be an interactive icon or other graphic artifact on the display, that a user my use to initiate interaction with the smart premise system.

In the situation depicted by FIG. 7 the Mother has entered the signal for interaction, and the smart router has, in response, provided an interactive interface 702. Field 703 in the interface in this example allows the Mother to enter her PIN to identify herself to the system. The PIN is needed in some cases because priorities are determined both by device priority and personal priority.

After the PIN is entered in this example the system displays in one embodiment a bar 704 indicating bandwidth share for the Mother at the present time based on her configured priority of 27. In alternative embodiments this indication may be by alphanumeric characters rather than graphics. It should be noted that at any particular point in time, the Mother may be the only user accessing bandwidth through the smart router, and she may potentially have access to all of the bandwidth. But if that is the situation it is unlikely the Mother will be seeking more bandwidth. Users will seek additional bandwidth typically because that user, using that device, is having a problem, or anticipates a problem. Think dropped audio in a phone conversation or hesitant video in a Skype call. So it may be assumed that requests for additional bandwidth may typically be requested when there are several users sharing the available bandwidth.

Returning now to FIG. 7 bar 704 may be in one embodiment interactive, such that a user, viewing display 702, may simply use, for example, an up arrow key to try to move the reading for the bar higher. In a device with a touch screen the user may just touch and drag the bar. In response, the system may refer to dynamic data indicating who is sharing bandwidth, and percent allocated to each user based on configuration and rules. In other embodiments there may be an input field for the user to enter a requested bandwidth percentage. In such a situation the system may have a rather complicated set of possible actions, determined by the current data as to usage and rules for certain situations.

In some situations, the system may query the user, in this case the Mother, for an indication of how long in minutes she believes she may need additional bandwidth. The Mother may need a clear telephone call that she knows will last only ten minutes. On the other hand, she may have a long conference planned with her business partners on Skype, perhaps an hour at least. Field 705 is such a request for time the system. The system may be able, for example, to double the Mother's bandwidth allotment for ten minutes, but not for sixty minutes, and may react differently depending on the time requested.

In one embodiment the system may be programmed to consider the individual user's priority to a greater extent than device priority. Referring back to FIG. 4 the Mother has individual priority 2, second only to the Father, but her priority of 27 in this case is heavily influenced by the device BC-F. So the system may, in one circumstance, in light of the request from the Mother, move her priority temporarily higher, probably not to 2, but perhaps to 10 as opposed to default 27 in this case. This may solve the problem for the Mother, and after the requested time, the combined priority for the Mother using device BC-F may revert again to 27.

In another circumstance the system may be programmed to alter priorities based on who is active with which devices. Returning again to FIG. 4, note that the Mother is individual priority 2. If the Father is away on business or at an off-site meeting, and the Mother becomes active on the network, the system may just identify the Mother, note that the Father is not in the system at present, which the system may know because the Father logged out for three days, or by any of several other ways, and move the Mother to #1 priority until such time as the Father reappears on the network.

In some embodiments the interplay between intelligence in SW 112 and a registered user may be considerably more complicated and granular than that depicted thus far by FIG. 7. For example, individual registered users may have pre-programmed privileges to monitor real-time usage data. It may be in some embodiments that one or two users may have such ability, but not all, and depth of privilege may vary between users. In such embodiments the Mother may, for example, access a display showing who is active and consuming bandwidth, and what the real-time allotment might be, as well as how it may be changing with time. For a privileged user operating a laptop, a pad device or a desktop computer, such a display may be at all times available, and simply minimized in the display, so that user may maximize the display at any point in time.

Changes in bandwidth allotment in real time, requested by users having trouble, will in some embodiments be serviced primarily based on heavy usage by lower priority devices. For example, a video game station primarily used by lower priority registered users will be forced to give ip bandwidth before, say, VoIP telephones.

In the embodiment depicted by FIG. 7, once the system responds to a change requested by a user with increased bandwidth, that new share may be indicated in bar 704, and when a time allotment expires, the change may be noted by bar 704 as well. The display of bar 704 may operate in a manner that the bar indicating share may move to where the requesting user drives it in the display, but immediately revert to whatever share solution the system determines to be correct under the circumstances.

It will be apparent to the skilled person that the exemplary display depicted in FIG. 7 and described above may be considerably different if the device used is, for example, a desktop computer or a laptop computer. Displays under different circumstances may be provided and managed by software 112 according to the type of device in use and in communication with the help system.

In another embodiment of the invention the smart router may be enabled through a portion of software 112 to recognize bandwidth being consumed by the user seeking help, which may be a result of some background or hidden function of the user's appliance. For example, the user's appliance may be downloading an update for an application enabled on the appliance. In some circumstances the system may make such a determination based upon packets being processed through the router that are recognized as having the user's appliance as a source, and a destination known to be a source for an update for an application. In such a circumstance the system may determine the bandwidth being used for such an update, and compare with the user's allocation according to priority and rules, and feed back to the user that the problem may be due to the update, and suggest that the user stop the download. In some cases the system may, with prior authorization from the user, automatically block the interfering activity to give the user the maximum bandwidth under the priorities and rules at the time. In another embodiment the system may be enabled to query the user's appliance for status of ongoing background or hidden activity, and either inform the user, or automatically, with permission, block the interfering activity.

Further to the above, the system may provide more general advice to users who access functions of SW 112. For example, it was mentioned that bandwidth may suffer simply by distance from the router if operating wirelessly, and this anomaly may not be countered by bandwidth allotment by rule. In response to a request for additional bandwidth, or a solution to a problem for a user operating a device with poor results, the system may be able to inform the user that moving to another part of the premise closer to the wireless router may have a positive effect. In some cases a move just to another part of a room, based on configuration and structure of the building may have a positive effect. Such advice may include suggestions of use at certain times, and that advice may be predicated on data history, indicating times of day and night that bandwidth is more available. The real-time monitoring by the system, extrapolated over time, may provide surprising intervals where extra bandwidth may be available. Another valuable advice the system may provide to a user advice to select audio mode rather than video mode for communication using Skype or Google Hangout, for example. Video mode of course requires considerably more bandwidth than audio.

In embodiments described above functions are described as resulting from execution of parts of SW 112 on a processor of smart router 105. However, in some embodiments software may be downloaded to individual devices in the smart premise, and may execute on those devices, providing essentially the same functions as described above. In some embodiments the SW may operate on an Internet-connected server, such as server 114 in FIG. 1. In some embodiments server 114, hosted by an enterprise providing hardware and software solutions for smart premise implementation and operation in embodiments of the present invention, may proved software in different implementations for smart premises, which may be selected and applied according to differences in the premises.

In one embodiment individual smart premise networks include a SW agent that may be part of SW 112 that, through monitoring bandwidth usage, defines usage statistics over time for all of the bandwidth consumers connected to and operating on the network and then suggests priority states for those components relative to a component hierarchy. Additional knowledge about each device may be collected and retained by smart router 105 such as, who operates the device, the activities assigned to the device, the capabilities of the device, and so on. This information may be presented upon request from the network administrator and may be useful for the administrator to re-set or confirm preset or suggested priority levels for the components. The agent may also include an interface for adding new appliances and systems (bandwidth consumers) to the network.

In description of embodiments above it is clear that a system is configured originally by a user having administrative authority, and that rules may be established, users may each be assigned a default priority, and devices registered in the system may also be assigned a default priority. Bandwidth throttling by the smart router may then be accomplished according to priority determined by the combination of a user's priority and priority of a device, perhaps altered also by rule in many cases (see FIG. 4). This basis of operation does not take into account that there is another important aspect, which is the use to which a device may be put by a user. For example, a particular user, having a specific default priority, may be communicating through the router through a device also having a specific default priority, and the smart router may treat that communication as a combination of the default priorities for the user and the device, as shown in FIG. 4, but this ignores the specific use, that is, what is the importance of the communication itself. A user, may, for example, be playing a video game at an Internet gaming site using a particular appliance (device), or the same user may be uploading a homework assignment to a school site using the same appliance. Clearly the use might also be prioritized to make the system more fair and efficient, and to afford greater bandwidth share to the more important communications, based on user, device, rules, and specific use.

Use, however, is perhaps more difficult to monitor and incorporate in bandwidth sharing than other priorities, and perhaps more difficult to configure with default priority. In one embodiment SW 112 may include intelligence for noting at the router during receipt and transmission of packets not only the device and the user involved in the smart premise network, but also the remote participant in a communication. This may be accomplished in many instances from packet headers. In the case of email communications, for example, there will be a “from” and a “to” address. If the communication is transmission into the Internet through the smart router to “to” address will identify the recipient, and in some cases recipients may be made known to the system and prioritized, particularly if frequently encountered. If the communication is from the Internet to a device in the smart network, the identity of the sender may also be prioritized by the same rationale. In the case of video, web browsing, and other end-point determinations, the nature of the communication may be similarly prioritized.

In one embodiment of the invention SW 112 includes code for tracking and recording URLs for Internet sources and destinations asserted and used by devices registered on the smart premise network. In one embodiment regular reports are provided for the administrator of the network, which the administrator may use to update priorities and rules, according to the uses to which the network users user their devices. In another embodiment this information is recorded and used by one or more algorithms that automatically update priorities and rules for bandwidth sharing through the smart router.

In one embodiment of the invention one or more machine-learning algorithms are employed as part of SW 112 to update priorities and rules, once default rules and priorities have been established, and individual users access the help features of the system to seek improved bandwidth allocation. To accomplish machine-learning adjustment of bandwidth allocation the system in one embodiment creates a record of individual access, adjustment and result, and this record is utilized periodically, along with other records and information, to adjust default bandwidth allocation.

Information available to the system to adjust bandwidth allocation for members automatically is considerable. This includes, for example, each change made to bandwidth allocation and distribution, as indicated just above, as a result of requests from individual members. It also includes manual input by an administrator that changes bandwidth allocation. Further the system may monitor variations to bandwidth at the smart router that do not come from throttling at the router, such as changes that might occur because of telephone system anomalies. Available bandwidth in many circumstances may vary by time-of-day, and by sharing in the local area. That is, there may be more than one smart network sharing a telephone circuit. Algorithms may be created and executed using many different combinations of information, and motivated by many different goals.

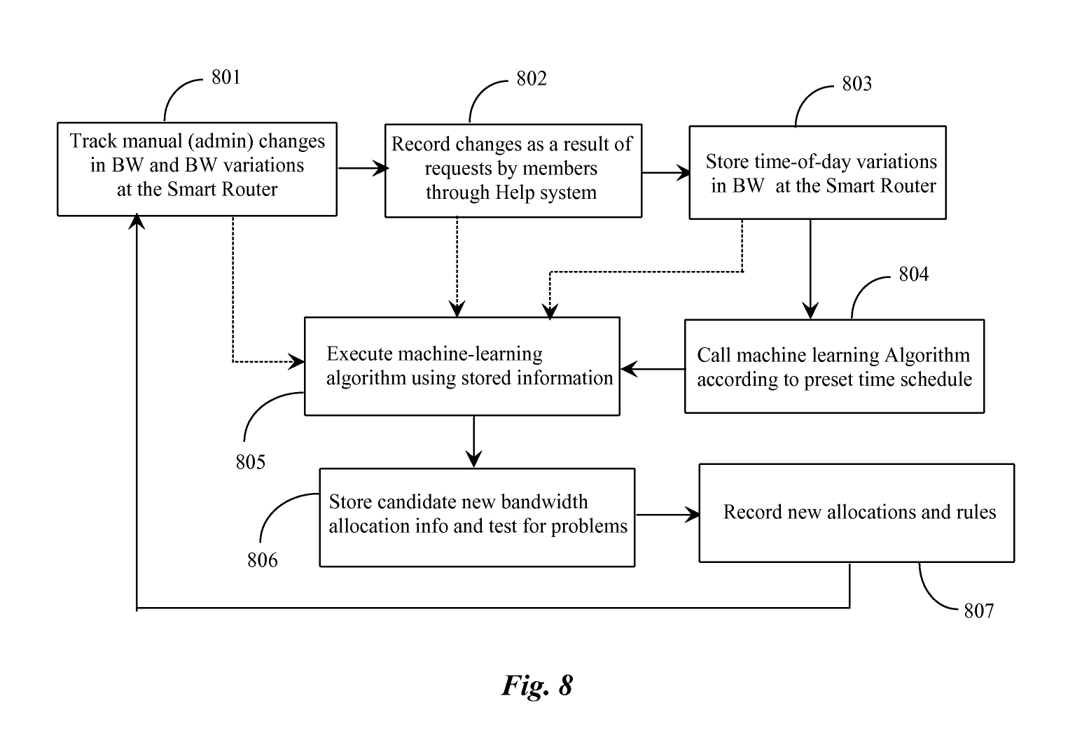

FIG. 8 is a flow diagram illustrating adjustment of bandwidth allocation for members of a smart premise network in one circumstance. The process depicted by FIG. 8 is a cyclic process that repeats on a predetermined time sequence, so description may start at any step. At step 801 SW 112 tracks administrative changes in BW allocation, and BW variations at the smart router due to any and all circumstances. At step 802 changes in BW allocation as a result of requests by individual members through the Help system described above are recorded. At step 803 time of day variations are recorded. At step 804 the system, based on a preset time sequence, calls a machine-learning algorithm, which is executed at step 805 pulling information from data storage from several steps as indicated by dotted lines. At step 806 the system stored the result of the calculations at step 805, and tests for problems that might be apparent. If there are no problems the new rules and allocations are stored at step 807, and these parameters are followed until the next machine-learning adjustment.

In different embodiments of the invention different algorithms and combinations of algorithms may be utilized. As described above, priorities are determined for users beyond initial configuration by a combination of vectors for identity, device or usage, and content type. A priority score may be represented as P=a1*x1+a2*x2+a3*x3+a4*x4, where a1, a2, a3, and a4 are a vector of weights specific to the identify of the user and attributes x1, x2, x3, and x4 are a vector of features of the system such as device, activity, content type. In this example we used four features. It is to be noted that there may be a much larger number of features “xn” of the system that can be measured and described this or similar ways. In different embodiments of the invention the weights “an” are adapted and learned over time with the further training of the requests or clarifications of the system users and the corrective actions or conformations of the administrative user.

It will be apparent to one with skill in the art of machine learning that the system of the present invention may continue to evolve as more data is processed and as changes occur due to infrastructure additions, alternate service providers available over the network, or other more general developments related to the entire infrastructure as a whole. It will also be apparent to the skilled person that the arrangement of elements and functionality for the invention is described in different embodiments in which each is exemplary of an implementation of the invention. These exemplary descriptions do not preclude other implementations and use cases not described in detail. The elements and functions may vary, as there are a variety of ways the hardware may be implemented and in which the software may be provided within the scope of the invention. The invention is limited only by the breadth of the claims below.

1. A smart premise system comprising:
a router having a processor, connection to a data repository, a primary port to Internet connection on a primary path, and wired connection or wireless coupling to individual ones of a plurality of bandwidth-using devices forming a local premise network, bandwidth-using devices sharing bandwidth on the primary port; and
software executing on the processor from a non-transitory medium, execution of the software providing:
a default bandwidth share and a set of rules for registered users and registered devices in the smart premise system, the default share managed by the router according to the default rules for each user of the system using a registered device; and
a mechanism for individual users to monitor their own bandwidth share in real time, and to request additional bandwidth from the system.

2. The system of claim 1 wherein the software provides a help initiation signal for individual registered devices, the signal, asserted, providing an interactive interface on a display associated with the device.

3. The system of claim 2 wherein the signal is one of a key or key sequence for an input device associated with the registered device, or an icon or other graphic artifact displayed interactively on a display associated with the device.

4. The system of claim 2 wherein the interactive interface provides an input field for a use enter a password or PIN number identifying the registered user to the system.

5. The system of claim 2 wherein the interactive interface provides an alphanumeric or a graphical indication of the bandwidth share afforded the user requesting help.

6. The system of claim 2 wherein the interactive interface provides an entry mechanism for a user to request a change in bandwidth share.

7. The system of claim 2 wherein the interactive interface provides an input mechanism for a user to indicate a time period for which an increase in bandwidth is requested.

8. The system of claim 2 wherein, in response to the help initiation signal being asserted, the software provides general suggestions for improvement in bandwidth share.

9. The system of claim 8 wherein the general suggestions include possible movement of a device within the system, switching to an alternative connection to the Internet, or using the device at a different time.

10. The system of claim 1 wherein 2 wherein, in response to a user asserting the help initiation signal, the system assigns to the requester a default priority associated with a different user having a higher priority.

11. A method comprising steps:
(a) executing help software from a non-transitory medium on a processor of a router in a system wherein registered users and registered devices are accorded a default priority for sharing bandwidth through the router; and
(b) providing by the software a mechanism for individual users to monitor their own bandwidth share in real time, and to request additional bandwidth from the system.

12. The method of claim 11 wherein the software provides a help initiation signal for individual registered devices, the signal, asserted, providing an interactive interface on a display associated with the device.

13. The method of claim 12 wherein the signal is one of a key or key sequence for an input device associated with the registered device, or an icon or other graphic artifact displayed interactively on a display associated with the device.

14. The method of claim 12 wherein the interactive interface provides an input field for a use enter a password or PIN number identifying the registered user to the system.

15. The method of claim 12 wherein the interactive interface provides an alphanumeric or a graphical indication of the bandwidth share afforded the user requesting help.

16. The method of claim 12 wherein the interactive interface provides an entry mechanism for a user to request a change in bandwidth share.

17. The method of claim 12 wherein the interactive interface provides an input mechanism for a user to indicate a time period for which an increase in bandwidth is requested.

18. The method of claim 12 wherein, in response to the help initiation signal being asserted, the software provides general suggestions for improvement in bandwidth share.

19. The method of claim 18 wherein the general suggestions include possible movement of a device within the system, switching to an alternative connection to the Internet, or using the device at a different time.

20. The method of claim 12 wherein, in response to a user asserting the help initiation signal, the system assigns to the requester a default priority associated with a different user having a higher priority.
